(19) United States
(12) Patent Application Publication
(10) Pub. No.: US 2025/0037061 A1
(43) Pub. Date: Jan. 30, 2025

(54) METHOD AND SYSTEM FOR IMPLEMENTING AN ANALYTICS OUTPUT INGESTION TOOL

(71) Applicant: JPMorgan Chase Bank, N.A., New York, NY (US)

(72) Inventors: Christopher K HAMILTON, Middletown, DE (US); Alexander HALISKY, Irving, TX (US); Mark H WOLGIN, Malvern, PA (US)

(73) Assignee: JPMorgan Chase Bank, N.A., New York, NY (US)

(21) Appl. No.: 18/225,456

(22) Filed: Jul. 24, 2023

(51) Int. Cl. G06Q 10/0639

(52) U.S. Cl. CPC G06Q 10/06393

(57) ABSTRACT

A system for implementing an analytics output ingestion tool. The system may include a processor and memory that stores instructions that, when executed by the processor, cause the processor to perform operations. The operations may include: receiving a current set of requirements; generating, for a current scenario that relates to an entity, a current milestone dataset of features associated with the entity; interrogating, to determine whether the current milestone dataset meets the current set of requirements, a set of current milestone data sources associated with the current milestone dataset; and when a determination is made that confirms when a determination is made that confirms that confirms that the current milestone dataset meets the current set of requirements, transmitting the current milestone dataset to a current milestone analyzer service for an analysis that is required for a current milestone.

### BACKGROUND

### 1. Field of the Invention

The field of the invention disclosed herein generally relates to a system for implementing an analytics output ingestion tool and, more particularly, to a method, system, and computer-readable storage medium for implementing technology for an analytics output ingestion tool that improves the efficiency of various intangible product production processes to provide a faster and more reliable overall process.

### 2. Background of the Invention

Today's economies include many industries that are based on the creation and/or transfer of an intangible product such as education, insurance, financial products, and healthcare, to name a few. However, for a business in one of these industries, it becomes increasingly more difficult to scale the production of such an intangible product as the business matures.

Additionally, industries that are based on the creation and/or transfer of an intangible product have evolved in many ways over the last decade. Most significantly, these industries have experienced increased competition and rapid advancements in their respective technological fields. As a result, the businesses that tend to thrive in those industries are the organizations that offer a higher quality product in less time and at a lower cost than their competitors, and this trifecta requires that such businesses: increase their production and comply with all applicable regulations; while also reducing the cost, and improving the efficiency and accuracy, of their production process(es). However, intangible product-based industries reached the limits of any feasible manual effort to this end long ago.

Accordingly, the production process(es) of these highly competitive, fast-paced industries now necessitate automated systems that adhere to standard, real-time computing principles. For example, a conventional data analyzer may be utilized to help process the data necessary to produce an intangible product, but this approach is not without its drawbacks because such an analyzer must be checked periodically to determine whether it has finished processing the necessary data. Therefore, this approach can add time to the production process by introducing gaps between: the point in time when the data analyzer actually finishes processing the necessary data; and the time of the determination that the data analyzer has processed the necessary data.

Additionally, conventional data analyzer utilization may also introduce an inefficiency (in the form of an unnecessary check) to the production process whenever a user checks the data analyzer before the necessary data has been processed. Hence, this approach (i.e., conventional data analyzer utilization) fails to adhere to standard, real-time computing principles.

These and other drawbacks exist in the large-scale production of certain intangible products. Accordingly, there is a need in the field of the herein-disclosed invention, for a technical solution to the foregoing limitations in the technology of existing systems.

### SUMMARY

The present disclosure, through one or more of its various aspects, embodiments, and/or specific features or sub-component, provides, inter alia, various systems, servers, devices, methods, media, programs and platforms for implementing an analytics output ingestion tool that improves the efficiency of various intangible product production processes.

According to an aspect of the present disclosure, a method is provided for implementing an analytics output ingestion tool. The method may comprise: receiving a current set of requirements for a current milestone analyzer service that is associated with a current milestone; generating, for a current scenario that relates to an entity, a current milestone dataset of features that are associated with the entity; interrogating, to determine whether the current scenario has reached a beginning of the current milestone and to determine whether the current milestone dataset meets the current set of requirements, a set of current milestone data sources that are associated with the current milestone dataset; and when a determination is made that confirms when a determination is made that confirms that confirms that the current milestone dataset meets the current set of requirements, transmitting, to the current milestone analyzer service, a complete current milestone dataset that comprises the current milestone dataset. The current scenario may be associated with a set of current scenario milestones that comprises the beginning and an end of the current milestone.

In the method, the interrogating may further comprise: when the current scenario is determined to have reached the beginning of the current milestone, applying the current set of requirements to the current milestone dataset to determine whether the current milestone dataset meets the current set of requirements.

The method may further comprise: when a determination is made that confirms that the current milestone dataset does not meet the current set of requirements, transmitting, to at least one data source from among the set of current milestone data sources, at least one remediation request for at least one requirement deficiency of the current milestone.

The method may further comprise: determining whether the current scenario has reached the end of the current milestone; when the current scenario is determined to have reached the end of the current milestone, notifying the current milestone analyzer service that the analytics output ingestion tool is ready to ingest a current milestone analytics output; and requesting that the current milestone analyzer transmit, to the analytics output ingestion tool, a current milestone notification that indicates that the current milestone analytics output is available for ingestion.

In the method, the analytics output ingestion tool may comprise a registered webhook endpoint and the current milestone notification comprises a webhook.

The method may further comprise: receiving the current milestone notification from the current milestone analyzer service; evaluating the current milestone analytics output to determine whether the current milestone analytics output is ready for ingestion; and when the evaluating determines that the current milestone analytics output is ready to be ingested, ingesting the current milestone analytics output.

The method may further comprise: determining whether the set of current scenario milestones includes a subsequent milestone; when it has been determined that the set of current scenario milestones includes the subsequent milestone, advancing to the subsequent milestone and repeat the method; when it has been determined that the set of current scenario milestones does not include the subsequent milestone, determining whether another scenario is available; when it has been determined that the other scenario is available, advance to the other scenario and repeat the method.

The method may further comprise, when the evaluating determines that the current milestone analytics output is not ready to be ingested: generating an evaluation of the current milestone analytics output, wherein the evaluation comprises a set of assessments of why the current milestone analytics output is not ready; and sending each assessment of the set of assessments to a respective location that is based on a corresponding assessment. The respective location may be associated with the current milestone analyzer.

In the method, the evaluating may comprise: determining whether the current analyzer received and analyzed the complete current milestone dataset; determining whether the current milestone analytics output is available and complete; and when a determination is made that confirms that the set of current scenario milestones includes a subsequent milestone, determining whether the current analyzer has developed a subsequent set of requirements for a subsequent milestone analyzer.

In the method, the current milestone notification may comprise a webhook.

According to another aspect of the present disclosure, a system is provided for implementing an analytics output ingestion tool. The system may comprise: a processor; and memory storing instructions. When executed by the processor, the instructions may cause the processor to perform operations comprising: receiving a current set of requirements for a current milestone analyzer service that is associated with a current milestone; generating, for a current scenario that relates to an entity, a current milestone dataset of features that are associated with the entity; interrogating, to determine whether the current scenario has reached a beginning of the current milestone and to determine whether the current milestone dataset meets the current set of requirements, a set of current milestone data sources that are associated with the current milestone dataset; and when a determination is made that confirms that the current milestone dataset meets the current set of requirements, transmitting, to the current milestone analyzer service, a complete current milestone dataset that comprises the current milestone dataset. The current scenario may be associated with a set of current scenario milestones that comprises the beginning and an end of the current milestone.

In the system, the interrogating may further comprise: when the current scenario is determined to have reached the beginning of the current milestone, applying the current set of requirements to the current milestone dataset to determine whether the current milestone dataset meets the current set of requirements.

In the system, when executed by the processor, the instructions may cause the processor to perform the operations further comprising: when a determination is made that confirms that the current milestone dataset does not meet the current set of requirements, transmitting, to at least one data source from among the set of current milestone data sources, at least one remediation request for at least one requirement deficiency of the current milestone.

In the system, when executed by the processor, the instructions may cause the processor to perform the operations further comprising: determining whether the current scenario has reached the end of the current milestone; when the current scenario is determined to have reached the end of the current milestone, notifying the current milestone analyzer service that the analytics output ingestion tool is ready to ingest a current milestone analytics output; and requesting that the current milestone analyzer transmit, to the analytics output ingestion tool, a current milestone notification that indicates that the current milestone analytics output is available for ingestion.

In the system, the analytics output ingestion tool may comprises a registered webhook endpoint and the current milestone notification comprises a webhook.

In the system, when executed by the processor, the instructions may cause the processor to perform the operations further comprising: receiving the current milestone notification from the current milestone analyzer service; evaluating the current milestone analytics output to determine whether the current milestone analytics output is ready for ingestion; and when the evaluating determines that the current milestone analytics output is ready to be ingested, ingesting the current milestone analytics output.

In the system, when executed by the processor, the instructions may cause the processor to perform the operations further comprising: determining whether the set of current scenario milestones includes a subsequent milestone; when it has been determined that the set of current scenario milestones includes the subsequent milestone, advance to the subsequent milestone and repeat the method; when it has been determined that the set of current scenario milestones does not include the subsequent milestone, determining whether another scenario is available; and when it has been determined that the other scenario is available, advance to the other scenario and repeat the method.

In the system, when executed by the processor, the instructions may cause the processor to perform the operations further comprising: when the evaluating determines that the current milestone analytics output is not ready to be ingested: generating an evaluation of the current milestone analytics output, wherein the evaluation comprises a set of assessments of why the current milestone analytics output is not ready; and sending each assessment of the set of assessments to a respective location that is based on a corresponding assessment. The respective location may be associated with the current milestone analyzer.

In the system, the evaluating may comprise: determining whether the current analyzer received and analyzed the complete current milestone dataset; determining whether the current milestone analytics output is available and complete; and when a determination is made that confirms the set of current scenario milestones includes a subsequent milestone, determining whether the current analyzer has developed a subsequent set of requirements for a subsequent milestone analyzer.

In the system, the current milestone notification may comprise a webhook.

According to yet a further aspect of the present disclosure, a non-transitory computer-readable medium is provided for implementing an analytics output ingestion tool. The analytics output ingestion tool may store instructions that, when executed by a processor, may cause the processor to perform operations comprising: receiving a current set of requirements for a current milestone analyzer service that is associated with a current milestone; generating, for a current scenario that relates to an entity, a current milestone dataset of features that are associated with the entity; interrogating, to determine whether the current scenario has reached a beginning of the current milestone and to determine whether the current milestone dataset meets the current set of requirements, a set of current milestone data sources that are associated with the current milestone dataset; and when a determination is made that confirms that the current milestone dataset meets the current set of requirements, transmitting, to the current milestone analyzer service, a complete current milestone dataset that comprises the current milestone dataset. The current scenario may be associated with a set of current scenario milestones that comprises the beginning and an end of the current milestone.

In the non-transitory computer-readable medium, the interrogating may further comprise: when the current scenario is determined to have reached the beginning of the current milestone, applying the current set of requirements to the current milestone dataset to determine whether the current milestone dataset meets the current set of requirements.

In the non-transitory computer-readable medium, when executed by the processor, the instructions may cause the processor to perform the operations further comprising: when a determination is made that confirms that the current milestone dataset does not meet the current set of requirements, transmitting, to at least one data source from among the set of current milestone data sources, at least one remediation request for at least one requirement deficiency of the current milestone.

In the non-transitory computer-readable medium, when executed by the processor, the instructions may cause the processor to perform the operations further comprising: determining whether the current scenario has reached the end of the current milestone; when the current scenario is determined to have reaches the end of the current milestone, notifying the current milestone analyzer service that the analytics output ingestion tool is ready to ingest a current milestone analytics output; and requesting a current milestone notification that indicates that the current milestone analytics output is available for ingestion.

In the non-transitory computer-readable medium, the analytics output ingestion tool may comprise a registered webhook endpoint and the current milestone notification comprises a webhook.

In the non-transitory computer-readable medium, when executed by the processor, the instructions may cause the processor to perform the operations further comprising: receiving the current milestone notification from the current milestone analyzer service; evaluating the current milestone analytics output to determine whether the current milestone analytics output is ready for ingestion; and when the evaluating determines that the current milestone analytics output is ready to be ingested, ingesting the current milestone analytics output.

In the non-transitory computer-readable medium, when executed by the processor, the instructions may cause the processor to perform the operations further comprising: determining whether the set of current scenario milestones includes a subsequent milestone; when it has been determined that the set of current scenario milestones includes the subsequent milestone, advance to the subsequent milestone and repeat the method; when it has been determined that the set of current scenario milestones does not include the subsequent milestone, determining whether another scenario is available; and when it has been determined that the other scenario is available, advance to the other scenario and repeat the method.

In the non-transitory computer-readable medium, when executed by the processor, the instructions may cause the processor to perform the operations further comprising, when the evaluating determines that the current milestone analytics output is not ready to be ingested: generating an evaluation of the current milestone analytics output, wherein the evaluation comprises a set of assessments of why the current milestone analytics output is not ready; and sending each assessment of the set of assessments to a respective location that is based on a corresponding assessment, wherein the respective location is associated with the current milestone analyzer.

In the non-transitory computer-readable medium, the evaluating may comprise: determining whether the current analyzer received and analyzed the complete current milestone dataset; determining whether the current milestone analytics output is available and complete; and when a determination is made that confirms the set of current scenario milestones includes a subsequent milestone, determining whether the current analyzer has developed a subsequent set of requirements for a subsequent milestone analyzer.

In the non-transitory computer-readable medium, the current milestone notification may comprise a webhook.

Thereby, the invention disclosed herein improves existing technology by providing an analytics output ingestion tool that improves the efficiency of various intangible product production processes to provide a faster and more reliable overall process.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 is a diagram of an exemplary computer system.

FIG. 2 is a diagram of an exemplary network environment that implements an Analytics Output Ingestion Tool.

FIG. 3 is a diagram of an exemplary perspective of a network environment that utilizes an Analytics Output Ingestion Tool to improve the efficiency of various intangible product production processes.

FIG. 4 is a flowchart of an exemplary process for implementing an Analytics Output Ingestion Tool that improves the efficiency of various intangible product production processes to provide a faster and more reliable overall process.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable storage media having instructions stored thereon for one or more aspects of the present technology as described and illustrated by way of the examples herein. In some examples, the instructions include executable code that, when executed by one or more processors, cause the processors to carry out steps necessary to implement the methods of the examples of this technology that are described and illustrated herein.

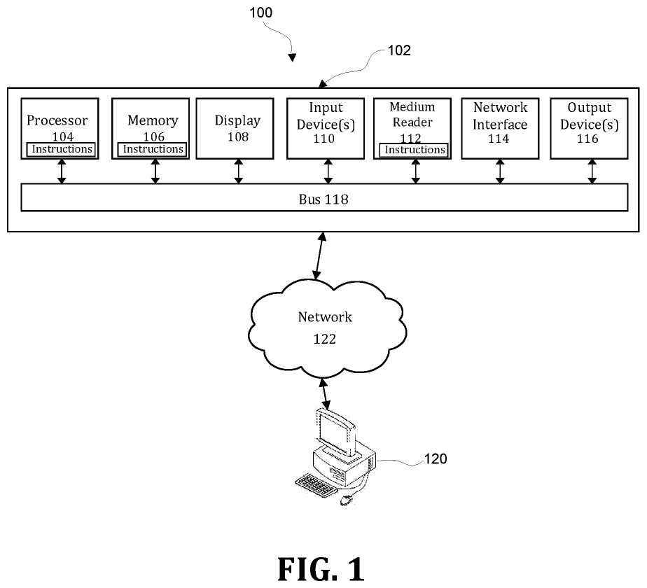

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide methods and systems for implementing an analytics output ingestion tool that ingests analytics outputs.

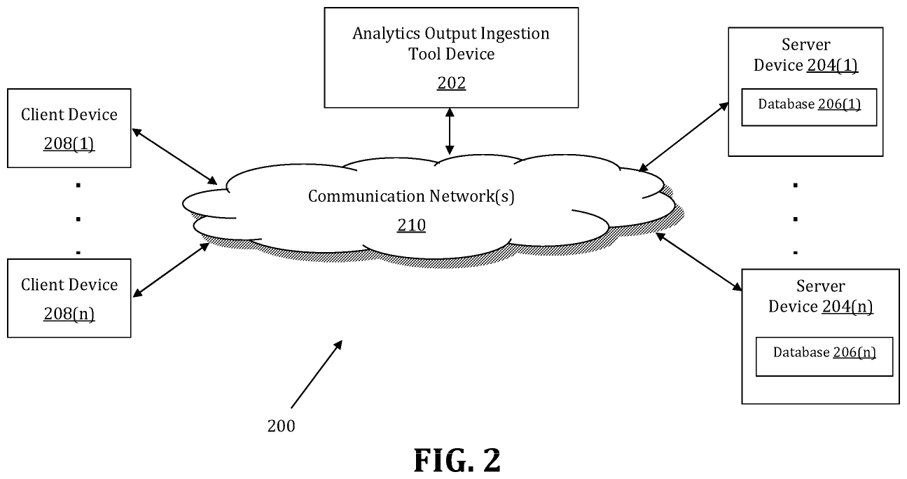

Referring to FIG. 2, a schematic of an exemplary network environment 200 an exemplary network environment that implements an analytics output ingestion tool, is illustrated. In an exemplary embodiment, the analytics output ingestion tool may be implemented on any networked computer platform, such as, for example, a personal computer (PC).

A method for implementing technology for values-based decision-making, diagnostics, and reporting may be implemented by an Analytics Output Ingestion Tool (AOIT) device 202. The AOIT device 202 may be the same or similar to the computer system 102 as described with respect to FIG. 1. The AOIT device 202 may be a rack-mounted server in a datacenter, an embedded microcontroller (MCU) in an electronic device, or another type of headless system, which is a computer system or device that is configured to operate without a monitor, keyboard and mouse. The AOIT device 202 may store one or more applications that can include executable instructions that, when executed by the AOIT device 202, cause the AOIT device 202 to perform actions, such as to transmit, receive, or otherwise process network communications, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the AOIT device 202 itself, may be located in virtual server(s) running in a cloud-based computing environment rather than being tied to one or more specific physical network computing devices. Also, the application(s) may be running in one or more virtual machines (VMs) executing on the AOIT device 202. Additionally, in one or more embodiments of this technology, virtual machine(s) running on the AOIT device 202 may be managed or supervised by a hypervisor.

In the network environment 200 of FIG. 2, the AOIT device 202 is coupled to a plurality of server devices 204(1)-204(n) that hosts a plurality of databases 206(1)-206(n), and also to a plurality of client devices 208(1)-208(n) via communication network(s) 210. A communication interface of the AOIT device 202, such as the network interface 114 of the computer system 102 of FIG. 1, operatively couples and communicates between the AOIT device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the AOIT device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, computer readable media, and AOIT devices that efficiently implement a method for an analytics output ingestion tool that ingests analytics outputs.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The AOIT device 202 may be a standalone device or integrated with one or more other devices or apparatuses, such as one or more of the server devices 204(1)-204(n), for example. In one particular example, the AOIT device 202 may include or be hosted by one of the server devices 204(1)-204(n), and other arrangements are also possible. As another example, the AOIT device 202 may be integrated with one or more other devices or apparatuses, such as one or more of the client devices 208(1)-208(n). Moreover, one or more of the devices of the AOIT device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the AOIT device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to a variety of databases.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the AOIT device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the AOIT device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the AOIT device 202, the server devices 204(1)-204(n), the databases 206(1)-206(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the AOIT device 202, the server devices 204(1)-204(n), the databases 206(1)-206(n), or the client devices 208(1)-208(n), for example, may be configured to operate as virtual instances on the same physical machine. In other words, one or more of the AOIT device 202, the server devices 204(1)-204(n), the databases 206(1)-206(n), or the client devices 208(1)-208(n) may operate on the same physical device rather than as separate devices communicating through communication network(s) 210. Additionally, there may be more or fewer AOIT devices 202, server devices 204(1)-204(n), databases 206(1)-206(n), or client devices 208(1)-208(n) than illustrated in FIG. 2.

In addition, two or more computing systems, databases or devices may be substituted for any one of the systems, databases or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

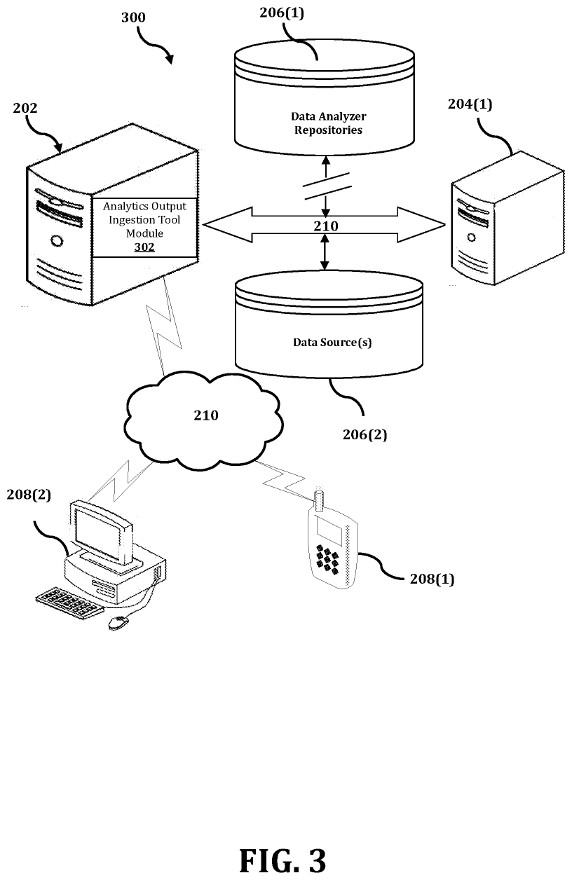

The AOIT device 202 is described and illustrated in FIG. 3 as including Analytics Output Ingestion Tool module 302, although it may include other rules, policies, modules, databases, or applications, for example. As will be described below, Analytics Output Ingestion Tool module 302 is configured to improve the efficiency of various intangible product production processes. Analytics Output Ingestion Tool module 302 may include software that is based on a microservices architecture.

Analytics Output Ingestion Tool module 302 may be integrated with one or more devices or apparatuses, such as client devices 208(1)-208(n), where Analytics Output Ingestion Tool module 302 may be implemented as an application or as an addon or plugin to another application of the one or more devices or apparatuses, and where Analytics Output Ingestion Tool module 302 may execute in the background.

An exemplary process 300 for application of an analytics output ingestion tool to an aspect of the network environment of FIG. 2 is illustrated as being executed in FIG. 3. Specifically, a first client device 208(1) and a second client device 208(2) are illustrated as being in communication with AOIT device 202. In this regard, the first client device 208(1) and the second client device 208(2) may be “clients” of the AOIT device 202 and are described herein as such. Nevertheless, it is to be known and understood that the first client device 208(1) and/or the second client device 208(2) need not necessarily be “clients” of the AOIT device 202, or any entity described in association therewith herein. Any additional or alternative relationship may exist between either or both of first client device 208(1), second client device 208(2) and AOIT device 202, or no relationship may exist.

Further, AOIT device 202 is illustrated as being able to access data analyzer repositories 206(1), and data sources 206(2). AOIT device 202 may comprise an analytics output ingestion tool that communicates with data analyzer repositories 206(1). In addition, the Analytics output ingestion tool of AOIT device 202 may also communicate with data sources 206(2). The Analytics Output Ingestion Tool module 302 may be configured to access these databases in order to ingest analytics outputs.

Moreover, AOIT device 202 may receive and transmit data via communication network(s) 210. AOIT device 202 may receive and transmit data such as code that is written in one or more of the following dialects: transaction control language (TCL), data manipulation language (DML), data control language (DCL) and data definition language (DFL). Additionally, via communication network(s) 210, AOIT device 202 may respectively receive and transmit data from and to one or more of the following devices: server device 204(1), data analyzer repositories 206(1), data sources 206(2), first client device 208(1), the second client device 208(2), and communication network(s) 210, for example.

The first client device 208(1) may be, for example, a smart phone. Of course, the first client device 208(1) may be any additional device described herein. The second client device 208(2) may be, for example, a personal computer(PC). Of course, the second client device 208(2) may also be any additional device described herein.

The client devices 208(1)-208(n) may represent, for example, computer systems of an organization or database network. The first client device 208(1) represent, for example, one or more computer systems of a department or cluster within the organization or database network. Of course, the first client device 208(1) may include one or more of any of the devices described herein. The second client device 208(2) may be, for example, one or more computer systems of another department or cluster within the organization or database network. Of course, the second client device 208(2) may include one or more of any of the devices described herein.

The process may be executed via the communication network(s) 210, which may comprise plural networks as described above. For example, in an exemplary embodiment, either or both of the first client device 208(1) and the second client device 208(2) may communicate with the AOIT device 202 via broadband or cellular communication. Of course, these embodiments are merely exemplary and are not limiting or exhaustive.

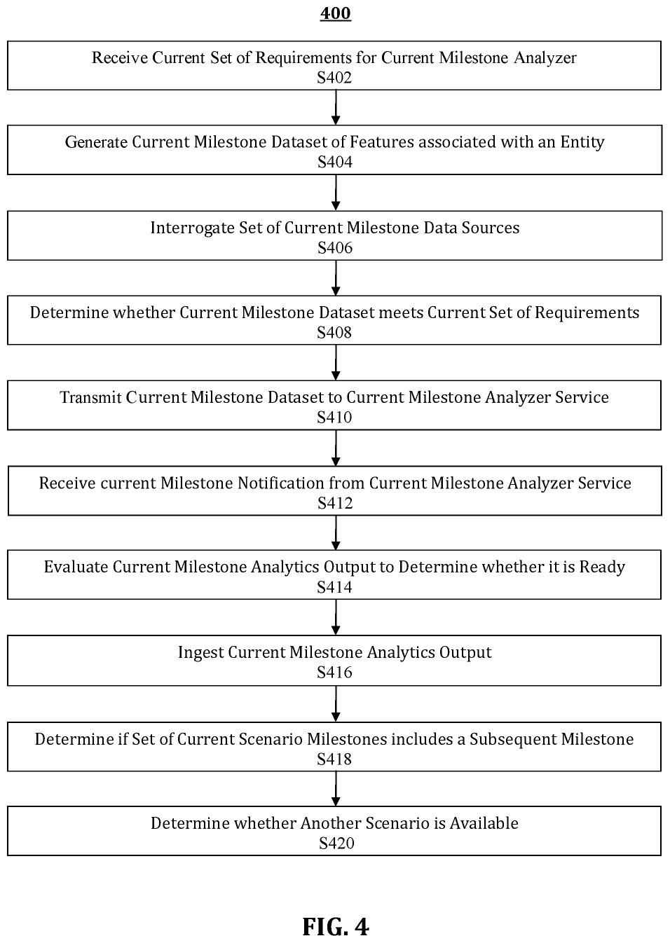

Analytics Output Ingestion Tool module 302 may execute a process for implementing an analytics output ingestion tool that improves the efficiency of various intangible product production processes to provide a faster and more reliable overall process. An exemplary process for implementing an analytics output ingestion tool is generally indicated at flowchart 400 in FIG. 4.

In process 400 of FIG. 4, at step S402, Analytics Output Ingestion Tool module 302 receives a current set of requirements for a current milestone analyzer service that is associated with a current milestone. The current milestone analyzer service may be provided by a server such as server 204(1), for example, and the current milestone may be a current stage of a production process that produces an intangible product for an entity.

At step S404, Analytics Output Ingestion Tool module 302 generates, for a current scenario that relates to the entity, a current milestone dataset of features that are associated with the entity. The current scenario may comprise a context of the intangible product, and the current scenario may be associated with a set of current scenario milestones that may comprise a beginning and an end of the current milestone.

At step S406, to determine whether the current scenario has reached the beginning of the current milestone, Analytics Output Ingestion Tool module 302 interrogates a set of current milestone data sources that are associated with the current milestone dataset.

At step S406, the interrogating may comprise, when a determination is made that confirms that the current milestone dataset does not meet the current set of requirements, and until it is determined that the current milestone dataset meets the current set of requirements: transmitting, to at least one data source from among the set of current milestone data sources, at least one remediation request for at least one requirement deficiency of the current milestone; receiving, from the at least one data source, an indication that the at least one requirement deficiency has been remediated; and determining whether the current milestone dataset meets the current set of requirements for the current milestone analyzer service.

When the current scenario is determined to have reached the beginning of the current milestone, to determine whether the current milestone dataset meets the current set of requirements, at step S408, Analytics Output Ingestion Tool module 302 applies the current set of requirements to the current milestone dataset.

When a determination is made that confirms that the current milestone dataset meets the current set of requirements, at step S410, Analytics Output Ingestion Tool module 302 transmits, to the current milestone analyzer service, a complete current milestone dataset that comprises the current milestone dataset.

After step S410, Analytics Output Ingestion Tool module 302 may: determine whether the current scenario has reached the end of the current milestone; when the current scenario is determined to have reached the end of the current milestone, notify the current milestone analyzer service that the analytics output ingestion tool is ready to ingest a current milestone analytics output; and request that the current milestone analyzer transmit, to the analytics output ingestion tool, a current milestone notification that indicates that the current milestone analytics output is available for ingestion. The analytics output ingestion tool may comprise a registered webhook endpoint and the current milestone notification may comprise a webhook.

At step S412, Analytics Output Ingestion Tool module 302 receives the current milestone notification from the current milestone analyzer service.

At step S414, Analytics Output Ingestion Tool module 302 evaluates the current milestone analytics output to determine whether the current milestone analytics output is ready for ingestion. The evaluating comprises: determining whether the current analyzer received and analyzed the complete current milestone dataset; determining whether the current milestone analytics output is available and complete; and when a determination is made that confirms the set of current scenario milestones includes a subsequent milestone, determining whether the current analyzer has developed a subsequent set of requirements for a subsequent milestone analyzer.

When the evaluating determines that the current milestone analytics output is not ready to be ingested, and until a re-evaluating determines that the current milestone analytics output is ready to be ingested, Analytics Output Ingestion Tool module 302 may: generate an evaluation of the current milestone analytics output; send each assessment of a set of assessments to a respective location that is based on a corresponding assessment; receive, from the respective location to which each assessment was sent, an assessment response; and re-evaluate the current milestone analytics output to determine whether the current milestone analytics output is ready for ingestion. The evaluation may comprise the set of assessments, the set of assessments may comprise assessments of why the current milestone analytics output is not ready, and the respective location may be associated with the current milestone analyzer.

When the evaluating determines that the current milestone analytics output is ready to be ingested, at step S416, Analytics Output Ingestion Tool module 302 ingests the current milestone analytics output.

At step S418, Analytics Output Ingestion Tool module 302 determines whether the set of current scenario milestones includes a subsequent milestone. When a determination is made that confirms that the set of current scenario milestones includes the subsequent milestone, Analytics Output Ingestion Tool module 302 advances to the subsequent milestone and returns to step S402.

When a determination is made that confirms that the set of current scenario milestones does not include the subsequent milestone, at step S420, Analytics Output Ingestion Tool module 302 determines whether another scenario is available; and when it has been determined that the other scenario is available, Analytics Output Ingestion Tool advances to the other scenario and returns to step S402. Then, after step S420, process 400 terminates.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

1. A method for implementing an analytics output ingestion tool, the method comprising:
receiving a current set of requirements for a current milestone analyzer service that is associated with a current milestone;
generating, for a current scenario that relates to an entity, a current milestone dataset of features that are associated with the entity, wherein the current scenario is associated with a set of current scenario milestones that comprises a beginning and an end of the current milestone;
interrogating, to determine whether the current scenario has reached the beginning of the current milestone and to determine whether the current milestone dataset meets the current set of requirements, a set of current milestone data sources that are associated with the current milestone dataset; and
when a determination is made that confirms that the current milestone dataset meets the current set of requirements, transmitting, to the current milestone analyzer service, a complete current milestone dataset that comprises the current milestone dataset.

2. The method of claim 1, wherein the interrogating further comprises:
when the current scenario is determined to have reached the beginning of the current milestone, applying the current set of requirements to the current milestone dataset to determine whether the current milestone dataset meets the current set of requirements.

3. The method of claim 1, further comprising:
when a determination is made that confirms that the current milestone dataset does not meet the current set of requirements, transmitting, to at least one data source from among the set of current milestone data sources, at least one remediation request for at least one requirement deficiency of the current milestone.

4. The method of claim 1, further comprising:
determining whether the current scenario has reached the end of the current milestone;
when the current scenario is determined to have reached the end of the current milestone, notifying the current milestone analyzer service that the analytics output ingestion tool is ready to ingest a current milestone analytics output; and
requesting that the current milestone analyzer transmit, to the analytics output ingestion tool, a current milestone notification that indicates that the current milestone analytics output is available for ingestion.

5. The method of claim 4, wherein the analytics output ingestion tool comprises a registered webhook endpoint and the current milestone notification comprises a webhook.

6. The method of claim 4, further comprising:
receiving the current milestone notification from the current milestone analyzer service;
evaluating the current milestone analytics output to determine whether the current milestone analytics output is ready for ingestion; and
when the evaluating determines that the current milestone analytics output is ready to be ingested, ingesting the current milestone analytics output.

7. The method of claim 6, further comprising:
determining whether the set of current scenario milestones includes a subsequent milestone;
when a determination is made that confirms that the set of current scenario milestones includes the subsequent milestone, advancing to the subsequent milestone and repeat the method;
when a determination is made that confirms that the set of current scenario milestones does not include the subsequent milestone, determining whether another scenario is available;
when a determination is made that confirms that the other scenario is available, advancing to the other scenario and repeat the method.

8. The method of claim 6, further comprising:
when the evaluating determines that the current milestone analytics output is not ready to be ingested:
generating an evaluation of the current milestone analytics output, wherein the evaluation comprises a set of assessments of why the current milestone analytics output is not ready; and
sending each assessment of the set of assessments to a respective location that is based on a corresponding assessment, wherein the respective location is associated with the current milestone analyzer.

9. The method of claim 6, wherein the evaluating comprises:
determining whether the current analyzer received and analyzed the complete current milestone dataset;
determining whether the current milestone analytics output is available and complete; and
when a determination is made that confirms that the set of current scenario milestones includes a subsequent milestone, determining whether the current analyzer has developed a subsequent set of requirements for a subsequent milestone analyzer.

10. The method of claim 6, wherein the current milestone notification comprises a webhook.

11. A system for implementing an analytics output ingestion tool, the system comprising:
a processor; and
memory storing instructions that, when executed by the processor, cause the processor to perform operations comprising:
receiving a current set of requirements for a current milestone analyzer service that is associated with a current milestone;
generating, for a current scenario that relates to an entity, a current milestone dataset of features that are associated with the entity, wherein the current scenario is associated with a set of current scenario milestones that comprises a beginning and an end of the current milestone;
interrogating, to determine whether the current scenario has reached the beginning of the current milestone and to determine whether the current milestone dataset meets the current set of requirements, a set of current milestone data sources that are associated with the current milestone dataset; and
when a determination is made that confirms that the current milestone dataset meets the current set of requirements, transmitting, to the current milestone analyzer service, a complete current milestone dataset that comprises the current milestone dataset.

12. The method of claim 11, wherein the interrogating further comprises:
when the current scenario is determined to have reached the beginning of the current milestone, applying the current set of requirements to the current milestone dataset to determine whether the current milestone dataset meets the current set of requirements.

13. The system of claim 11, wherein when executed by the processor, the instructions cause the processor to perform the operations further comprising:
determining whether the current scenario has reached the end of the current milestone;
when the current scenario is determined to have reached the end of the current milestone, notifying the current milestone analyzer service that the analytics output ingestion tool is ready to ingest a current milestone analytics output; and
requesting that the current milestone analyzer transmit, to the analytics output ingestion tool, a current milestone notification that indicates that the current milestone analytics output is available for ingestion.

14. The system of claim 13, wherein when executed by the processor, the instructions cause the processor to perform the operations further comprising:
receiving the current milestone notification from the current milestone analyzer service;
evaluating the current milestone analytics output to determine whether the current milestone analytics output is ready for ingestion; and
when the evaluating determines that the current milestone analytics output is ready to be ingested, ingesting the current milestone analytics output.

15. The method of claim 14, wherein when executed by the processor, the instructions cause the processor to perform the operations further comprising:
when the evaluating determines that the current milestone analytics output is not ready to be ingested:
generating an evaluation of the current milestone analytics output, wherein the evaluation comprises a set of assessments of why the current milestone analytics output is not ready; and
sending each assessment of the set of assessments to a respective location that is based on a corresponding assessment, wherein the respective location is associated with the current milestone analyzer.

16. The method of claim 14, wherein the evaluating comprises:
determining whether the current analyzer received and analyzed the complete current milestone dataset;
determining whether the current milestone analytics output is available and complete; and
when a determination is made that confirms that the set of current scenario milestones includes a subsequent milestone, determining whether the current analyzer has developed a subsequent set of requirements for a subsequent milestone analyzer.

17. A non-transitory computer-readable medium for implementing an analytics output ingestion tool, wherein the non-transitory computer-readable medium stores instructions that, when executed by a processor, cause the processor to perform operations comprising:
receiving a current set of requirements for a current milestone analyzer service that is associated with a current milestone;
generating, for a current scenario that relates to an entity, a current milestone dataset of features that are associated with the entity, wherein the current scenario is associated with a set of current scenario milestones that comprises a beginning and an end of the current milestone;
interrogating, to determine whether the current scenario has reached the beginning of the current milestone and to determine whether the current milestone dataset meets the current set of requirements, a set of current milestone data sources that are associated with the current milestone dataset; and
when a determination is made that confirms that the current milestone dataset meets the current set of requirements, transmitting, to the current milestone analyzer service, a complete current milestone dataset that comprises the current milestone dataset.

18. The non-transitory computer-readable medium of claim 17, wherein when executed by the processor, the instructions cause the processor to perform the operations further comprising:
determining whether the current scenario has reached the end of the current milestone;
when the current scenario is determined to have reaches the end of the current milestone, notifying the current milestone analyzer service that the analytics output ingestion tool is ready to ingest a current milestone analytics output; and
requesting a current milestone notification that indicates that the current milestone analytics output is available for ingestion.

19. The non-transitory computer-readable medium of claim 18, wherein when executed by the processor, the instructions cause the processor to perform the operations further comprising:
receiving the current milestone notification from the current milestone analyzer service;
evaluating the current milestone analytics output to determine whether the current milestone analytics output is ready for ingestion; and
when the evaluating determines that the current milestone analytics output is ready to be ingested, ingesting the current milestone analytics output.

20. The non-transitory computer-readable medium of claim 19, wherein the evaluating comprises:
determining whether the current analyzer received and analyzed the complete current milestone dataset;
determining whether the current milestone analytics output is available and complete; and
when a determination is made that confirms the set of current scenario milestones includes a subsequent milestone, determining whether the current analyzer has developed a subsequent set of requirements for a subsequent milestone analyzer.
